(19) United States
(12) Patent Application Publication
(10) Pub. No.: US 2022/0065527 A1
(43) Pub. Date: Mar. 3, 2022

(54) METHODS AND COMPOSITIONS FOR DELIVERY OF CARBON DIOXIDE

(71) Applicant: CARBONCURE TECHNOLOGIES INC., Dartmouth (CA)

(72) Inventors: Dean Paul FORGERON, White's Lake (CA); Brad VICKERS, Bedford (CA); Brandon BURNS, Beaverbank (CA); Josh BROWN, Hamilton (CA); George Sean MONKMAN, Halifax (CA); Kevin CAIL, Sarasota, FL (US)

(21) Appl. No.: 17/413,174

(22) PCT Filed: Dec. 13, 2019
(86) PCT No.: PCT/US19/66407

§ 371 Date: Jun. 11, 2021

Related U.S. Application Data
(60) Provisional application No. 62/779,020, filed on Dec. 13, 2018.

(51) Int. Cl. F25J 1/00; C01B 32/55; B65G 53/30; F17C 9/02; F17C 13/04; B28C 5/42; B28C 5/02; B28C 5/46; C04B 40/02

(52) U.S. Cl. CPC F25J 1/0032; F17C 2225/0138; B65G 53/30; F17C 9/02; F17C 13/04; B28C 5/4268; B28C 5/4237; B28C 5/02; B28C 5/466; C04B 40/0231; F25J 2270/02; F25J 2280/50; F17C 2250/043; F17C 2250/0439; F17C 2250/0443; F17C 2221/013; F17C 2223/013; F17C 2225/0123; C01B 32/55

(57) ABSTRACT

Provided herein are methods, apparatus, and systems for delivering carbon dioxide as a mixture of solid and gaseous carbon dioxide to a destination.

### CROSS-REFERENCE

This application claims priority to U.S. Provisional Patent Application No. 62/779,020, filed Dec. 13, 2018, which is incorporated by reference herein in its entirety. This application is related to U.S. patent application Ser. No. 15/650,524, filed Jul. 14, 2017, and to U.S. patent application Ser. No. 15/659,334, filed Jul. 25, 2017, both of which are incorporated herein by reference.

### BACKGROUND OF THE INVENTION

The use of snow horns to produce a mixture of gaseous and solid carbon dioxide from liquid carbon dioxide is well known. A snow horn is typically used to deliver a relatively large dose of carbon dioxide as solid carbon dioxide, and it is generally not necessary or possible to achieve a precise or reproducible dose of carbon dioxide from the snow horn, in a desired ratio of solid to gaseous carbon dioxide, especially at low doses and/or under intermittent conditions.

### SUMMARY OF THE INVENTION

In one aspect, provided herein are methods.

In certain embodiments, provided herein is a method for intermittently delivering a dose carbon dioxide in solid and gaseous form to a destination comprising (i) transporting liquid carbon dioxide from a source of liquid carbon dioxide to an orifice via a first conduit, wherein (a) the first conduit comprises material that can withstand the temperature and pressure of the liquid carbon dioxide, and (b) the pressure drop through the orifice and the configuration of the orifice are such that solid and gaseous carbon dioxide are produced as the carbon dioxide exits the orifice; (ii) transporting the solid and gaseous carbon dioxide through a second conduit, wherein the ratio of the length of the second conduit to the length of the first conduit is at least 1:1; and (iii) directing the carbon dioxide that exits the second conduit to a destination. In certain embodiments, the length, diameter, and material of the first conduit are such that, after a transition period, the liquid carbon dioxide entering the first conduit arrives at the orifice as at least 90% liquid carbon dioxide when the ambient temperature is less than 30° C. In certain embodiments, the second conduit has a smooth bore. In certain embodiments, the first conduit is not insulated. In certain embodiments, the method further comprises directing the solid and gaseous carbon dioxide from the end of the second conduit into a third conduit, wherein the third conduit comprises a portion configured to slow the flow of the carbon dioxide through the portion of third conduit sufficiently to cause the solid carbon dioxide to clump before it exits the third conduit through an opening. In certain embodiments, the portion of the third conduit configured to slow the flow of carbon dioxide is an expanded portion compared to the second conduit. In certain embodiments, the ratio of the length of the third conduit to the length of the second conduit is less than 0.1:1. In certain embodiments, the third conduit has a length between 1 and 10 feet. In certain embodiment, the third conduit has an inner diameter between 1 inch and 3 inches In certain embodiments, the ratio of the length of the second conduit to that of the first conduit is at least 2:1. In certain embodiments, the first conduit has a length of less than 15 feet. In certain embodiments, the first conduit has an inner diameter between 0.25 and 0.75 inches. In certain embodiments, the first conduit comprises inner material of braided stainless steel. In certain embodiments, the second conduit has a length of at least 30 feet. In certain embodiments, the second conduit has an inner diameter between 0.5 and 0.75 inch. In certain embodiments, the second conduit comprises inner material of PTFE. In certain embodiments, the third conduit comprises rigid material, and is operably connected to a fourth conduit comprising flexible material. In certain embodiments, the combined length of the third and fourth conduits is between 2 and 10 feet. In certain embodiments, the first conduit comprises a valve for regulating the flow of carbon dioxide, wherein the method further comprising determining a pressure and a temperature between the valve and the orifice, and determining a flow rate for the carbon dioxide based on the temperature and the pressure. In certain embodiments, the flow rate is determined by comparing the pressure and temperature to a set of calibration curves for flow rates at a plurality of temperatures and pressures. In certain embodiments, the destination to which the carbon dioxide is directed is within a mixer. In certain embodiments, the mixer is a concrete mixer. In certain embodiments, the carbon dioxide is directed to a place in the mixer where, when the mixer is mixing a concrete mix, a wave of concrete folds over onto the mixing concrete. In certain embodiments, the concrete mixer is a stationary mixer. In certain embodiments, the mixer is a transportable mixer. In certain embodiments, the mixer is a drum of a ready-mix truck. In certain embodiments, the total heat capacity of the first and/or second conduit is no more than that which would cool to the ambient temperature in less than 30 seconds when liquid carbon dioxide flows through the conduit. In certain embodiments, the orifice and are such that solid and gaseous carbon dioxide exits the orifice in a mixture that comprises at least 40% solid carbon dioxide. In certain embodiments, the conduits are directed to add carbon dioxide to a concrete mixer, and wherein cement is added to the mixer through a cement conduit comprising a first portion comprising a rigid chute connected to a second portion comprising a flexible boot configured to allow a ready-mix truck to move a hopper on the ready-mix into the boot so that the boot flops into the hopper, allowing cement and other ingredients to fall into a drum of the ready-mix truck through the boot, wherein the third conduit is positioned alongside the first portion of the cement conduit and the fourth conduit is positioned to move and direct itself with the second portion of the cement conduit. In certain embodiments, aggregate is added to the mixer through an aggregate chute adjacent to the cement chute, and where the first portion of the third conduit is positioned to reduce contact with aggregate as it exits the aggregate chute. In certain embodiments, the first portion of the third conduit extends to the bottom of the first portion of the cement chute and the forth conduit is attached to the end of the third conduit, and extends from the end of the third conduit to the bottom of the rubber boot or near the bottom of the rubber boot when the rubber boot is positioned within the hopper of the ready-mix truck. In certain embodiments, the fourth conduit is positioned within x cm of the center of the rubber boot, on average, where x=1, 2, 3, 4, 5, 6, 7, 8, 9, 10, 12, 15, 20, 25, 30, 35, 40, 45, 50, 60, 70, 80, or 90 cm when the rubber boot is positioned to load concrete materials into the drum of the ready-mix truck.

In another aspect, provided herein are apparatus.

In certain embodiments, provided herein is an apparatus for delivering solid and gaseous carbon dioxide comprising (i) a source of liquid carbon dioxide; (ii) a first conduit, wherein the first conduit comprises a proximal end operably connected to the source of liquid carbon dioxide, and a distal end operably connected to an orifice, wherein the first conduit is configured to transport liquid carbon dioxide under pressure to the orifice, and wherein the orifice is open to atmospheric pressure, or close to atmospheric pressure, and is configured to convert the liquid carbon dioxide to a mixture of solid and gaseous carbon dioxide as it passes through the orifice; (iii) a second conduit operably connected to the orifice for directing the mixture of gaseous and solid carbon dioxide to a desired destination, wherein the second conduit has a smooth bore, and wherein the ratio of the length of the first conduit to the length of the second conduit is less than 1:1. In certain embodiments, the ratio of the length of the first conduit to the length of the second conduit is less than 1:2. In certain embodiments, the ratio of the length of the first conduit to the length of the second conduit is less than 1:5. In certain embodiments, the first conduit is less than 20 feet long. In certain embodiments, the first conduit is less than 15 feet long. In certain embodiments, the first conduit is less than 12 feet long. In certain embodiments, the first conduit is less than 5 feet long. In certain embodiments, the first conduit comprises a valve prior to the orifice to regulate the flow of the liquid carbon dioxide. In certain embodiments, the apparatus further comprises a first pressure sensor between the valve and the orifice. In certain embodiments, the apparatus further comprises a second pressure sensor between the source of liquid carbon dioxide and the valve. In certain embodiments, the apparatus further comprises a third pressure sensor after the orifice. In certain embodiments, the apparatus further comprises a temperature sensor between the valve and the orifice. In certain embodiments, the apparatus further comprises a control system operably connected to the first pressure sensor and the temperature sensor. In certain embodiments, the controller receives a pressure from the first pressure sensor and a temperature from the temperature sensor and calculates a flow rate of carbon dioxide in the system from the pressure and temperature. In certain embodiments, the controller calculates the flow rate based on a set of calibration curves for the apparatus. In certain embodiments, the set of calibration curves is produced with a calibration setup comprising a source of liquid carbon dioxide, a first conduit, an orifice, a valve in the first conduit before the orifice, a pressure sensor between the valve and the orifice, and a temperature sensor between the valve and the orifice, wherein the material of the first conduit, the length and diameter of the first conduit, and the material and configuration of the orifice, are the same as or similar to those of the apparatus. In certain embodiments, the set of calibration curves is produced by determining the flow of carbon dioxide at a plurality of temperatures as measured at the temperature sensor and a plurality of pressures as measured at the pressure sensor. In certain embodiments, the apparatus further comprises a third conduit, operably attached to the second conduit, wherein the third conduit has a larger inside diameter than the second conduit and wherein the diameter and length of the third conduit are configured to slow the flow of the gaseous and solid carbon dioxide and to cause clumping of the solid carbon dioxide. In certain embodiments, the first conduit is not insulated.

In certain embodiments, provided herein is an apparatus for delivering solid and gaseous carbon dioxide in low doses in an intermittent manner of repeated doses of solid and gaseous carbon dioxide comprising (i) a source of liquid carbon dioxide; (ii) a first conduit, wherein the first conduit comprises a proximal end operably connected to the source of liquid carbon dioxide, and a distal end operably connected to an orifice, wherein the first conduit is configured to transport liquid carbon dioxide under pressure to the orifice, and wherein the orifice is open to atmospheric pressure and is configured to convert the liquid carbon dioxide to a mixture of solid and gaseous carbon dioxide as it passes through the orifice; (iii) a valve in the conduit between the source of carbon dioxide and the orifice, to regulate the flow of liquid carbon dioxide; (iv) a heat source operable connected to the section of conduit between the valve and the orifice, and to the orifice, wherein the heat source is configured to warm the conduit and orifice between doses to convert liquid or solid carbon dioxide to gas which is vented through the orifice. In certain embodiments, the apparatus further comprises a heat sink operably connected to the heat source. In certain embodiments the apparatus further comprises (v) a second conduit operably connected to the orifice for directing the mixture of gaseous and solid carbon dioxide to a desired destination In certain embodiments, the second conduit has a smooth bore. In certain embodiments, the ratio of the length of the first conduit to the length of the second conduit is less than 1:1.

In another aspect, provided herein are systems.

In certain embodiments, provided herein is a system for delivering solid and gaseous carbon dioxide in an intermittent manner at doses of carbon dioxide of less than 60 pounds, with a time between doses of at least 5 minutes, wherein the system is configured to deliver repeated doses with a ratio of solid to gaseous carbon dioxide of at average of least 1:1.5 in each dose, in less than 60 seconds per dose, at an ambient temperature of 35° C. or less. In certain embodiments, the system is configured to deliver the repeated doses of carbon dioxide with a coefficient of variation of less than 10%. In certain embodiments, the system is configured to deliver repeated doses of carbon dioxide with a coefficient of variation of less than 5%. In certain embodiments, the system comprises a source of liquid carbon dioxide and a conduit from the source to an apparatus configured to convert the liquid carbon dioxide to solid and gaseous carbon dioxide, wherein the conduit is not required to be insulated. In certain embodiments, the conduit is not insulated. In certain embodiments, the system further comprises a second conduit connected to the apparatus to convert the liquid carbon dioxide to solid and gaseous carbon dioxide, wherein the second conduit delivers the solid and gaseous carbon dioxide to a desired location. In certain embodiments the ratio of lengths of the first conduit to the second conduit is less than 1:1.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a direct injection assembly for carbon dioxide that does not require a gas line to keep the assembly free of dry ice between runs.

### DETAILED DESCRIPTION OF THE INVENTION

The methods and compositions of the present invention provide reproducible dosing of solid and gaseous carbon dioxide, under intermittent conditions and at low doses and short delivery times, without using apparatus and methods that lead to significant loss of carbon dioxide in the process. Methods and apparatus as provided herein can allow very precise dosing, e.g., dosing with a coefficient of variation (CV) over repeated doses of less than 10%, less than 8%, less than 6%, less than 5%, less than 4%, less that 3%, less than 2%, or less than 1%; for example, when dosing repeated batches of less than, e.g., 200, 150, 100, 90, 80, 70, 60, 50, 40, 30, 20, or 10 pounds of carbon dioxide per batch, where the carbon dioxide is delivered as a liquid in a first conduit of the system, and exits through an orifice into a second conduit of the system, where it flows as a mixture of solid and gaseous carbon dioxide to a destination In particular, the methods and compositions of the invention are useful when doses of carbon dioxide are low and injection times are short, but it is desired to deliver a mixture of solid and gaseous carbon dioxide with a high solid/gas ratio, even if there is a significant pause between runs and even at relatively high ambient temperatures. For example, the methods and compositions of the invention can be used to deliver a dose of carbon dioxide of at least 5, 10, 15, 20, 25, 30, 35, 40, 45, 50, 60, 70, 80, 90, 100, or 120 pounds and/or not more than 10, 15, 20, 25, 30, 35, 40, 45, 50, 60, 70, 80, 90, 100, or 120, such as 5-120 pounds, or 5-90 pounds, or 5-60 pounds, or 5-40 pounds, or 10-120 pounds, or 10-90 pounds, or 10-60 pounds, or 10-40 pounds, in an intermittent fashion where the average time between doses is at least 2, 3, 4, 5, 6, 7, 8, 9, 10, 12, 15, 20, 25, 30, 40, 50, 60, 80, 100, or 120 minutes, where the delivery time for the dose is less than 180, 150, 120, 100, 90, 80, 70, 60, 55, 50, 45, 40, 35, 30, 25, 20, 15, or 10 seconds. The ratio of solid/gaseous carbon dioxide delivered to the target may be at least 0.3, 0.32, 0.34, 0.36, 0.38, 0.40, 0.41, 0.42, 0.43, 0.44, 0.45, 0.46, 0.47, 0.48, or 0.49. The reproducibility of doses between runs may be such that the coefficient of variation (CV) is less than 20, 15, 12, 10, 9, 8, 7, 6, 5, 4, 3, 2, or 1%. These values can hold even at relatively high ambient temperatures, such as average temperatures above 10, 15, 20, 21, 22, 23, 24, 25, 26, 27, 28, 29, 30, 31, 32, 33, 34, 35, 36, 37, 38, 39, or 40° C.

For example, using the methods and compositions of the invention, it is possible to deliver intermittent doses of carbon dioxide of 5-60 pounds, at an average solid/gas ratio of at least 0.4, with a delivery time of less than 60 seconds and at least 2, 4, 5, 7, or 10 minutes between runs, where the ambient temperature is at least 25° C., with a CV of less than 10%, or even with a CV of less than 5%, 4%, 3%, 2%, or 1%. Such short delivery times, high solid/gas ratios, and high reproducibility, achieved during intermittent low doses, are not possible with current apparatus without a significant waste of carbon dioxide, e.g., by continuously venting gaseous carbon dioxide formed between runs from the line. Methods and systems provided herein can allow accurate, precise and reproducible dosing of low doses of carbon dioxide, e.g. as described above, with liquid carbon dioxide being converted to a mixture of solid and gaseous carbon dioxide, without venting of gaseous carbon dioxide in the line that carries the liquid carbon dioxide.

In current conventional set-ups, in which carbon dioxide is converted to solid and gas, a source of liquid carbon dioxide is connected to an orifice via a conduit, where the orifice is open to the atmosphere. Generally, beyond the orifice the conduit expands for a relatively short distance, such as one to four feet, to direct the combination of solid and gaseous carbon dioxide to a desired destination. In a typical current operation, the conduit leading from the source of liquid carbon dioxide to the orifice is well insulated; nonetheless, in intermittent operations, the conduit will warm to some degree, depending on ambient temperature and time between uses. If the time between uses is long enough, it may warm sufficiently that when a new burst of liquid carbon dioxide is released into the conduit, carbon dioxide in the conduit has been converted to gas between runs and some of the carbon dioxide released into the conduit will be converted to gaseous carbon dioxide, and often the first carbon dioxide exiting the orifice is just gaseous carbon dioxide. This continues until the liquid carbon dioxide cools the conduit to a sufficiently low temperature that it is maintained in liquid form from its source to the orifice, and at this point the desired mixture of solid and gaseous carbon dioxide is delivered. However, the first portion of carbon dioxide will be entirely or almost entirely gaseous carbon dioxide, and will be relatively large since the length of the conduit extends from the source of carbon dioxide to the point of use. For use in, e.g., food manufacturing and other such processes, this initial burst of gaseous carbon dioxide is not a problem, since precise dosage of a solid/gas mix is not required and since applications are done at intervals that allow little time for equilibration of the conduit with the outside temperature.

However, there are applications for which a precise dose of carbon dioxide, delivered in a desired ratio of solid to gaseous carbon dioxide, at low doses and in an intermittent manner, is desired. This requires that the carbon dioxide from the source reaching the orifice be maintained in liquid form with a sufficiently small amount of gas formed that it does not significantly impact the dosing. It is possible to do this through cumbersome apparatus such as liquid-gas separators in the line, or a countercurrent mechanism in the snow horn itself to maintain the carbon dioxide in liquid form before it reaches the orifice (see, e.g., U.S. Pat. No. 3,667,242). However, such methods require venting of gas or reliquifaction, both of which are wasteful, inefficient, and expensive to implement. It is especially wasteful when the distance from the source of carbon dioxide to the orifice, which is generally placed near the desired target for the snow produced by the snow horn, is long, as this provides ample opportunity for the liquid carbon dioxide to convert to gas. There are many applications where the configuration of various apparatus at the site do not allow a short distance between the source of liquid carbon dioxide, e.g., a tank of liquid carbon dioxide, and the final destination for the carbon dioxide. For example, in a concrete operation, such as a ready-mix concrete operation or a precast operation, if it is desired to deliver a dose of carbon dioxide to concrete mixing in a mixer, the liquid carbon dioxide tank often must be positioned at a distance from the delivery point, e.g., often 50 or more feet from the delivery point.

Provided herein are methods and compositions that 1) allow transfer of liquid carbon dioxide from a source, such as a tank, to an orifice where it is converted to solid and gaseous carbon dioxide, while maximizing the percentage of carbon dioxide reaching the orifice that is liquid, without having to vent carbon dioxide or use an insulated line; 2) maximize the amount of carbon dioxide that remains solid as it travels from the orifice to its point of use; and 3) allows for repeatable, reproducible dosing under a variety of ambient conditions and at low doses of carbon dioxide.

In the methods and compositions provided herein, a first conduit, also referred to herein as a transfer conduit or transfer line, carries liquid carbon dioxide from a holding tank to an orifice open to atmospheric or near-atmospheric pressure, configured to convert the liquid carbon dioxide to solid and gaseous carbon dioxide. The first conduit is configured to minimize the amount of gaseous carbon dioxide produced initially in a run, and during the course of the run. Thus, the length of the first conduit from the source of liquid carbon dioxide to the orifice that produces the mixture of solid and gaseous carbon dioxide is kept short, preferably as short as possible and/or to a set, calibrated length, and the diameter is kept to a value that allows for a small total volume in the first conduit without being so narrow as to induce a pressure drop sufficient to cause conversion of liquid to gaseous carbon dioxide within the conduit. The first conduit is generally not insulated, and is made of material, such as braided stainless steel, that can withstand the temperature and pressure of the liquid carbon dioxide. Since the length is short, the total heat capacity of the first conduit is low, and the conduit rapidly equilibrates with the temperature of liquid carbon dioxide as it initially enters the conduit. It will be appreciated that at very low ambient temperatures, i.e., ambient temperatures below the temperature of the carbon dioxide in the storage tank (which can vary depending on the pressure in the tank), the conduit will be at a low enough temperature that virtually no liquid carbon dioxide will convert to gas at the start of the run, but at ambient temperatures above that at which the carbon dioxide will remain liquid in the conduit, there inevitably is some gas formation; how much gas is formed depends on the temperature which the conduit has reached between runs and the heat capacity of the conduit. However, even if the ambient temperature is relatively high (e.g., above 30° C.) and the time between runs is sufficient for the conduit to equilibrate with ambient temperature, only a very short time is required to cool the conduit to the temperature of liquid carbon dioxide flowing through, for example, less than 10, 8, 7, 6, 5, 4, 3, 2, or 1 second. As liquid carbon dioxide flows through the conduit, further heat will be lost through the wall of the conduit to the outside air (assuming an ambient temperature above that of the liquid carbon dioxide) during the time of the flow, but since the diameter and length of the conduit are kept low, flow is rapid and relatively little heat is lost as carbon dioxide flows to the orifice. Thus, within a few seconds, e.g., within 10 seconds, or within 8 seconds, or within 5 seconds, a large proportion of the carbon dioxide remains as liquid as it reaches the orifice, such as at least 80, 90, 92, 95, 96, 97, 98, or 99%. Because the ratio of solid to gaseous carbon dioxide exiting the orifice is related, at least in part, to the proportion of carbon dioxide that is liquid as it reaches the orifice, within seconds a ratio approaching 1:1 solid:gas (by weight) may be reached.

The first conduit may be of any suitable length, but must be short enough that a significant amount of gas will no accumulate in the conduit (and require removal before liquid carbon dioxide can reach the orifice). Thus, the first conduit can have a length of less than 30, 25, 20, 17, 15, 14, 13, 12, 11, 10, 9, 8, 7, 6, 5, 4, 3, 2, 1, 0.5, or 0.25 feet, and/or not more than 25, 20, 17, 15, 14, 13, 12, 11, 10, 9, 8, 7, 6, 5, 4, 3, 2, 1, 0.5, 0.25, 0.1, or 0.01 feet, such as 0.1-25 feet, or 0.1-15 feet, or 0.1-10 feet, or 1-15 feet. Different systems, e.g., systems provided to different customers, may all contain the same length, diameter, and/or material of first conduit, e.g. a conduit of 10-foot length, or any other suitable length, so that calibration curves made using the same length and type of conduit can be applied to different systems.

The inner diameter (I.D.) of the first conduit may be any suitable diameter; in general, a smaller diameter is preferred, to decrease mass and travel time to the orifice, but the diameter cannot be so small that it causes a sufficient pressure drop over the length of the conduit to cause liquid carbon dioxide to convert to gas. The I.D. of the first conduit thus may be at least 0.1, 0.2, 0.3, 0.4, 0.5, 0.6, 0.7, 0.8, 0.9, or 1.0 inch, and not more than 0.2, 0.3, 0.4, 0.5, 0.6, 0.7, 0.8, 0.9, 1.0, 1.5, or 2 inch, such as 0.1-0.8, or 0.1-0.6, or 0.2-0.7, or 0.2-0.6, or 0.2-0.5 inch, for example, about 0.25 inch, or 0.30 inch, or 0.375 inch, or 0.5 inch. The first conduit delivering the carbon dioxide to the orifice need not be highly insulated, and in fact can be made of material with high thermal conductivity, e.g., a metal conduit with thin walls. For example, a braided stainless steel line, such as would be found inside a vacuum jacket line (but without the vacuum jacket) may be used. The conduit may be rigid or flexible. Because the conduit is short and small diameter, it has a low heat capacity, and thus, as liquid carbon dioxide is released into the conduit, it is cooled to the temperature of the liquid carbon dioxide very quickly, and the liquid carbon dioxide also passes its length quickly, so that there is only a short lag time from the start of carbon dioxide delivery to the time when carbon dioxide delivered to the orifice is substantially all liquid carbon dioxide, or at least 80, 85, 90, 95, 96, 97, 98, or 99% liquid carbon dioxide. The lag time may be less than 20, 15, 10, 9, 8, 7, 6, 5, 4, 3, 2, or 1 second. The lag time will depend on ambient temperature and the time between runs; at low ambient temperature and/or short time between runs, very little or no time will be needed to bring the first conduit to the temperature of the liquid carbon dioxide. At low enough ambient temperature, i.e., at or below the temperature of liquid carbon dioxide at the pressure being used, virtually no time is needed to equilibrate the first conduit, as it is already at a temperature that will not produce any gaseous carbon dioxide as the liquid carbon dioxide passes through. An exemplary conduit is ⅜ inX120 in OA 321SS Braided hose C/W St. steel MnPt Attd each end.

Typically, the first conduit will contain a valve for initiating and stopping carbon dioxide flow to the orifice, with the valve being situated near the orifice. The section of conduit between the valve and the orifice, and/or conduit situated after the orifice, can be subject to icing between runs. In certain embodiments, a separate gas conduit is run from the carbon dioxide source to the section of the first conduit between the valve and the orifice, and carbon dioxide gas is sent through this section and the orifice to remove residual liquid carbon dioxide between runs.

In alternative embodiments, no gas conduit is required. In these embodiments, a heat source is situated such that the section of conduit between the valve and the orifice, the orifice itself, and/or a section of conduit after the orifice, may be heated sufficiently between runs that any liquid or solid in these sections and/or the orifice is converted to gas (this would generally only be required when the solenoid is closed and the pressure drops, thereby causing the carbon dioxide to drop to the gas/solid phase portion of the phase diagram, resulting in some gas and solid snow which needs to be converted to gas by introducing heat before the next cycle). In addition, enough suitable material may be included with the heat source so that a heat sink of sufficient capacity to sublime any dry ice formed between the valve and orifice between cycles is created. When liquid carbon dioxide is run through the valve the valve temperature approaches the equilibrium temperature of the liquid; closing the valve effectively results in the liquid trapped between the solenoid and orifice turning to gas and dry ice in an approximately 1:1 ratio with the dry ice at, e.g., −78.5° C. This causes some more cooling of the valve, but to work there has to be enough mass in the heat sink to take this cooling and still have capacity to sublime the dry ice, which has an enthalpy of sublimation of 571 kJ/kg (25.2 kJ/mole) before reaching −78.5° C. An exemplary heat sink may be built with a finned design and comprise any suitable material, e.g., aluminum. The fins assist the heat sink to gain heat from the surroundings quickly and aluminum can be used due to its rapid heat conduction properties, allowing heat to quickly move to the valve and sublime the dry ice. In certain embodiments, induction heating may be used. This design allows cycles in short intervals, e.g., a minimum interval of 10, 8, 7, 6, 5, 4, 3, 2, or 1 min, for example, a minimum interval time of about 5 minutes. Heating bands may be used in colder areas and to give some redundancy, such as band claim heaters, e.g., a first band claim heater wrapped around the heat sink that is under the liquid valve and a second band claim heater wrapped around the orifice. In certain embodiments, one or more induction heaters may be used. In certain embodiments, one or more (e.g., 2) redundant pressure sensors may be included, e.g., so that if one fails the other can start reading.

In these embodiments, the need for the gas line is obviated, reducing the materials in the system. In addition, because a source of gaseous carbon dioxide is not required in addition to a source of liquid carbon dioxide, the system may be run with smaller tanks that are not configured to draw off gaseous carbon dioxide, such as mizer tanks or even portable dewars which are not designed to output very high gas flow rates, e.g., soda fountain tanks. These are readily available for immediate installation in such facilities, thus eliminating the need to commission custom tanks that are small enough for the operation being fitted, but also fitted with a gas line.

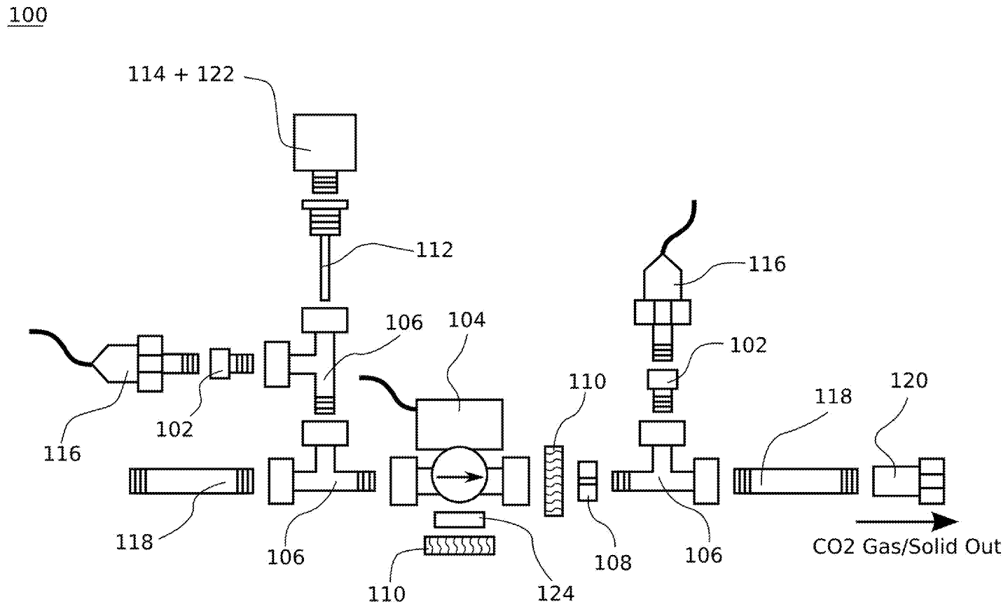

An example of a system that does not require a separate gas line is shown in FIG. 1. The CO2 piping assembly 100 includes fitting 102 (e.g., ½ inch MNPT to ¼ inch FNPT), valve 104 (e.g. ½ inch FNPT Stainless Steel Solenoid Valve, cryo liquid rated), fitting 106 (e.g. ½ inch MNPT×½ inch 2FNPT Tee), nozzle 108 (e.g. stainless steel orifice), heater 110, fitting 112 (e.g ½ inch MNPT Thermowell), probe 114 (e.g. ½ inch MNPT temperature probe), transmitter 116 (e.g., ¼ inch MNPT pressure sensor and transmitter), fitting 118 (e.g. ½ inch MNPT×4 inch nipple), fitting 120 (e.g. ½ inch FNPT×¾ inch FNPT), transmitter 122 (e.g., temperature transmitter, which can allow the probe to read temperatures below 0° C.), and heat sink 124.

The apparatus may contain a variety of sensors, which can include pressure and/or temperature sensors. For example, there may be a first pressure sensor prior to the valve, which indicates tank pressure, a second pressure sensor after the valve but before the orifice, and/or a third pressure sensor just after the orifice. One or more temperature sensors may be used, e.g., after the valve but before the orifice, and/or after the orifice. Feedback from one or more of these sensors may be used to, e.g., determine the flow rate of carbon dioxide. Flow rate may be determined through calculation using one or more of the pressure or temperature values. See, e.g., U.S. Pat. No. 9,758,437.

Additionally or alternatively, flow rate may be determined by comparison to calibration curves, where such curves can be obtained by measuring flow, by, e.g., measuring change in weight of a liquid carbon dioxide tank, or any other suitable method, using a conduit and orifice that are similar to or identical to those used in the operation, at various ambient temperatures and tank pressures. In either case, measurements of the appropriate pressure and/or temperature in the system may be taken at intervals, such as at least every 0.01, 0.1, 0.2, 0.3, 0.4, 0.5, 0.6, 0.7, 0.8, 0.9, 1, 1.5, 2, 3, 4, or 5 seconds and/or not more than every 0.1, 0.2, 0.3, 0.4, 0.5, 0.6, 0.7, 0.8, 0.9, 1, 1.5, 2, 3, 4, 5, or 6 seconds. The control system may also calculate an amount of carbon dioxide delivered, based on flow rate and time. In certain embodiments, such as for a concrete operation, the control system may be configured to send a signal to a central controller for the concrete operation each time a certain amount of carbon dioxide has flowed through the system; the central controller may be configured to, e.g., count the signals and stop the flow of carbon dioxide after a predetermined number of signals, corresponding to the desired dose of carbon dioxide, have been received. This is similar to the manner in which such controllers can regulate the amount of admixture added to a concrete mix. In some systems the admixture is pore weighted, in which case the system simulates batching up to a given weight by mimicking a load cell out put, then when signaled to drop the carbon dioxide into the mixer, the system counts backwards from the target dosage using the actual discharge carbon dioxide. This involves receiving a signal and providing a feedback voltage based on the weight in the simulated (ghost) scale.

Alternatively, temperatures and pressures of the system may be matched to one or more appropriate calibration curves, or an array of curves which are interpolated to develop an injection equation, and, for a given dose, the time to deliver that dose is based on the appropriate injection equation or equations. The control system may shut off carbon dioxide flow after the appropriate time has elapsed. The calibration curve being used at any given time may vary depending on temperature and/or pressure readings for that time.

In certain embodiments, a temperature sensor is used that gives instantaneous or nearly instantaneous feedback of liquid carbon dioxide temperature and allows for increased accuracy when metering. It can also quickly detect when only gas is flowing through the system or if the tank is close to empty. Without being bound by theory, it is thought that after the orifice snow formation is occurring at temperatures less than −70° C. and the area of solid formation starts to impact the temperature of the liquid before the orifice, thus increasing the flow rate. This temperature sensor flow model can also indicate when a storage tank is out of equilibrium (e.g., after tank fill, when ambient temperatures are less than the liquid temperature, when the pressure builder on the tank is turned off, etc.). This model may allow for very low CVs, e.g., less than 5%, or less than 3%, or less than 2%, or less than 1%. This model allows removal of assumptions of the carbon dioxide tank and the equilibrium between the pressure and temperature of the liquid carbon dioxide. This model reads the pressure of the tank at the beginning of injection and calculates the expected temperature of the liquid carbon dioxide based on a boiling curve equation derived from the carbon dioxide phase diagram. The system also takes an initial temperature reading and calculates the transition time which is the time from liquid valve open to flow liquid flow. During the transition time it is expected that a mixture of gas and liquid carbon dioxide and a gas/liquid flow equation is used; afterwards a liquid flow equation is used to calculate the flow of carbon dioxide. The model uses a linear equation derived from multiple injections (e.g., over 10, 100, 500, or over 1000 injections) across a range of tank pressures and is dependent on upstream pressure. The model also has a pressure multiplier where it calculates the drop-in pressure from the inlet liquid pressure sensor to the upstream pressure sensor and modifies the flow as the difference between these two sensors deviates. If there is any obstruction in the piping of the system, the multiplier will adjust the flow accordingly. The temperature multiplier reads the temperature sensor and compared to the calculated liquid carbon dioxide temperature. As the sensor reads temperatures lower than the calculated value, or higher, the temperature multiplier modifies the flow accordingly. Existing systems may have new pressure sensors, taller valve enclosure for quick and easy repairs, and to increase durability a new check and hydraulic fitting stand on the downstream pressure sensor to remove the sensor from the cold region of snow formation after the orifice. The hydraulic stand has proved to reduce the rate of failed downstream pressure sensors significantly.

The carbon dioxide is converted to a mixture of gaseous and solid carbon dioxide at the orifice; the ratio of solid to gas produced at the orifice depends on the proportion of carbon dioxide reaching the orifice that is liquid. If the carbon dioxide reaching the orifice is 100% liquid, the proportion of solid to gaseous carbon dioxide in the mix of solid and gaseous carbon dioxide exiting the orifice can approach 50%. The orifice may be any suitable diameter, such as at least 1/64, 2/64, 3/64, 4/64, 5/64, 6/64, or 7/64 inch and/or no more than 2/64, 3/64, 4/64, 5/64, 6/64, 7/64, 8/64, 9/64, 10/64, 11/64, or 12/64 inch, such as about 5/64 inch, or about 7/64 inch. The length of the orifice must be sufficient that liquid carbon dioxide passing through does not freeze; in addition, the orifice may be flared to prevent plugging. In certain systems, a dual orifice manifold block is used that allows one valve to feed two orifices and two discharge lines.

In dual orifice systems, a given flow of carbon dioxide may be sent to the destination in a shorter time, and/or flows may be sent to two different destinations, and/or flow may be sent to a single destination at two different points in the destination (e.g., two different points in a mixer such as a concrete mixer), which can allow for more efficient uptake of carbon dioxide at the destination. This can obviate problems of reliability and accuracy in certain systems, for example, in a twin shaft or roller mixer for concrete, or other systems with very short cycle times. Thus, a dual orifice system can allow for both greater delivery in a given time (e.g., up to 1.8× that of a single orifice system; due to thermodynamic changes within the system it does not reach the theoretical 2×) and more targeted delivery (to, e.g., two different points in a mixer) allowing, e.g. greater uptake efficiency. A dual orifice system may be manufactured and used in any suitable manner. For example, a steel manifold, such as a rolled steel or stainless steel manifold, can be full machined and contain one inlet and two outlets, with suitable orifices, e.g., orifices of sizes described herein, such as 7/64″ orifices. The manifold can have connections for two downstream pressure sensors and a connection for the temperature sensor and upstream pressure sensor tee to reduce the mass of the system and the time that liquid and metal are in contact. The dual injection system calculates the flow rate through both orifices. The dual injection system can also have an additional smooth boare discharge hose (second conduit, as described herein), additional injection nozzle, additional downstream pressure sensor with stand, and/or two points of discharge into the mixer.

The mixture of gaseous and solid carbon dioxide is then led from the orifice to its place of use, e.g., in the case of concrete operation such as a ready-mix operation or a precast operation, to a position to deliver the mixture to a mixer containing a cement mix comprising hydraulic cement and water, such as a drum of a ready-mix truck or a central mixer, by a second conduit, also referred to herein as a delivery conduit or delivery line. The second conduit is configured to deliver the mixture of solid and gaseous carbon dioxide to its place of use with very little conversion of solid to gaseous carbon dioxide, so that the mixture of solid and gaseous carbon dioxide delivered at the point of use is still at a high ratio of solid to gas, for example, the proportion of solid carbon dioxide in the mixture can be at least 35, 36, 37, 38, 39, 40, 41, 42, 43, 44, 45, 46, 47, 48, or 49% of the total.

The second conduit is typically configured to minimize friction along its length and also minimize heat exchange with the ambient atmosphere, and also provide a small total volume so that flow rate is maximized. For example, the second conduit can be a smooth bore conduit of relatively small diameter. Any suitable means may be used to provide a smooth bore for the second conduit, such as ensuring that no irregularities on the inside surface of the conduit occur and that there are no convolutions of the conduit. A material may be used that has a coating such as polytetrafluoroethylene (PTFE), which serves to keep the conduit bore smooth, so long as there are not substantial irregularities or convolution. The thermal mass of the hose is low due to the thin PTFE and small amount of stainless steel braiding. It can be insulated, e.g., with conventional pipe insulation. The conduit generally should be smooth (not convoluted) to allow smooth flow, and it must be able to withstand low temperatures; i.e., the dry ice (snow) that passes through the hose will be at a temperature of −78° C. Exemplary second conduits are the SmoothFlex series produced by PureFlex, Kentwood, Mich. The materials used in the SmoothFlex series and weight make these good candidates to ensure minimum warming during its transit from the orifice to its destination. This maximizes the solid carbon dioxide fraction as the sublimation rate is kept low. The second conduit may be flexible or rigid or a combination thereof; in certain embodiments at least a portion can be flexible in order to be easily positioned or for changing position. The second conduit can conduct the mixture of solid and gaseous carbon dioxide for a long distance with little conversion of solid to gas, since the transit time through the conduit is relatively short due to the force generated from the sudden conversion of the liquid carbon dioxide to gas and subsequent expansion of 500-fold or more, forcing the mixture of gas and solid through the conduit. The inside diameter of the second conduit may be any suitable inside diameter to allow rapid passage of the carbon dioxide, for example, at least 0.1, 0.2, 0.3, 0.4, 0.5, 0.6, 0.7, 0.8, 0.9, or 1.0 inch, and/or not more than 0.2, 0.3, 0.4, 0.5, 0.6, 0.7, 0.8, 0.9, 1.0, 1.5, or 2 inch, such as 0.5 inch, or 0.625 inch, or 0.750 inch. The second conduit may be, e.g., at least 5, 10, 15, 20, 25, 30, 35, 40, 45, 50, 55, 60, 65, 70, 80, 90, or 100 feet long, in order to reach the final point where carbon dioxide will be used; length of the second conduit will in general depend on the particular operational setup in which carbon dioxide is being used. Because the first conduit typically is kept as short as possible, and the second conduit must be a length suitable to reach to point of use, which is often far from the injector orifice, the ratio of length of the second conduit to that of the first conduit can be at least 0.5, 0.7, 1.0, 1.2, 1.5, 2.0, 2.5, 3.0, 3.5, 4.0, 4.5, 5.0, 6, 7, 8, 9, or 10, or greater than 10. For example, the first conduit can be not more than 10 feet long while the second conduit may be at least 20, 30, 40, or 50 feet long. The second conduit may be placed inside another conduit, such as a loose fitting plastic hose, e.g., to prevent kinking during installation. The second conduit may be further insulated, e.g., with pipe insulation, to further minimize heat gain between injections from external sources.

In certain embodiments, admixture may be added to the carbon dioxide stream as it is delivered. The admixture can be, e.g., liquid. A small amount of liquid admixture can be bled into the discharge line after the orifice. The liquid may quickly freeze into solid form and be carried along with the carbon dioxide into the mixer. The frozen admixture is carried into the concrete mix along with the carbon dioxide, and melts or sublimes in the concrete mixture. This method is particularly useful when adding an admixture that has a synergistic effect with the carbon dioxide and/or an admixture that can influence the carbon dioxide mineralization reaction. For example, the admixture TIPA imparts benefits at very small doses, but it is typically added in liquid cocktail form so the small dose is accompanied with a larger amount of carrier fluid. If only the active ingredient were added then the small amount could be distributed over the dose of carbon dioxide. Admixtures systems could be smaller if the chemicals do not need to be added in dilute solutions.

The second (delivery) conduit can be attached to a third conduit, also referred to herein as a targeting conduit. The third conduit can be a larger diameter than the second conduit, to allow for the solid/gas carbon dioxide to slow and mix, so that the solid carbon dioxide clumps together into larger pellets. This is useful, e.g., in a concrete operation where carbon dioxide is added to a mixing cement mix, so that pellets are large enough to be subsumed in the mixing cement before sublimating to a significant degree. The third conduit may be any suitable inside diameter, so long as it allows for sufficient slowing and clumping for the desired use, for example, at least at least 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.2, 3.4, 3.8, or 4 inches, and/or not more than 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.2, 3.4, 3.8, 4 or 4.5 inches, such as 0.5-4 inches, or 0.5-3 inches, or 0.5-2.5 inches, or about 2 inches. The third conduit may be any suitable length to allowed desired clumping without slowing the carbon dioxide so much, or for so long, that material sticks to the walls or sublimates to a significant degree, e.g., a length of at least 6, 8, 10, 12, 14, 16, 18, 20, 22, 24, 28, 32, 36, 40, 44, or 48 inches, and/or not more than 8, 10, 12, 14, 16, 18, 20, 22, 24, 28, 32, 36, 40, 44, 48, 54, 60, 72, 84 inches, for example, 2-8 feet, or 2-6 feet, or 3-6 feet, or 3-5 feet. The third conduit is typically made of a material that is rigid, and durable enough to withstand the conditions in which it is used. For example, in a concrete mixing operation, the third conduit is often positioned in the chute through which materials, including aggregates, are funneled into the mixer, and comes into repeated contact with the moving aggregates, and should be of sufficient strength and durability to withstand repeated contact with the aggregates on a daily basis. This may be as much as 20 tons of material per truck, and 400-500 trucks per month. Conventional snow horn materials will not withstand such an environment. A suitable material is stainless steel, of suitable diameter, such as ⅛ to ¼ inch. In some cases it may be desirable to install an armor, e.g., in high-wear location, to increase the thickness, e.g., to ½ inch or even thicker. The third conduit is typically a high-wear item and may be serviced periodically, e.g., every 3-6 months depending on production. In certain operations, e.g., where the third conduit is not moved, or rarely moved or moved only slightly between runs, the third conduit may be the final conduit in the system. This is the case, e.g., in stationary mixers, such as central mixers used in, e.g., ready-mix operations.

In some operations, such as concrete mix operations in which mix materials are dropped into the drum of a ready-mix truck, materials are dropped through a chute which ends in a flexible portion, to allow the chute to be placed in the hopper of the drum and then removed. In such a situation, a fourth conduit of flexible material, also called an end conduit herein, may be attached to the third conduit in order to move with the flexible chute used to drop the concrete materials. The inside diameter of the flexible conduit is such that it fits snugly over the outside diameter of the third conduit. Any material of suitable flexibility and durability may be used in the fourth conduit, such as silicone.

In certain embodiments, a token system is used as a security measure. For example, at intervals (e.g., monthly) a unique key (or “token”) is generated and distributed to the customer if the customer has no outstanding fees; if there are outstanding fees or other irregularities, the token may be withheld. The customer enters the token into the system, e.g., via touchscreen or on a web interface display (acts the same as the touch screen but is displayed on batching computer, that is, is appropriate for a potential installation of systems without touchscreen). At the end of the time interval (e.g., month) the system program disables the system unless the unique key has been entered, for example, without the unique key the system goes into idle mode, and even if a start injection signal is sent to the system, it is ignored. The same can happen if, e.g., the network connection of the system is lost for a period of time (for example, if a customer disables the network signal in an attempt to run the system without the unique key). Additionally or alternatively, outside connectors may be used on the enclosure for inputs and outputs that allows the provider to manually or automatically disable the system if any attempt is made to alter the enclosure. There is no reason for the customer or installer to open the enclosure; in the event of a failed unit the customer can be requested to unhook the external connections and a replacement unit can be sent to be swapped out with the failed unit.

### EXAMPLE 1

A ready-mix concrete plant provides dry batching in its trucks; i.e., dry concrete ingredients are placed in the drum of a truck with water and concrete is mixed in the trucks. It is desired to deliver carbon dioxide to the trucks while the concrete is mixing, where the carbon dioxide is a mixture of solid and gaseous carbon dioxide in a high ratio of solid carbon dioxide, e.g., at least 40% solid carbon dioxide. There is no room in the batching facility for a tank of liquid carbon dioxide to feed the line to the truck, so the liquid carbon dioxide tank is located 50 feet or more from the final destination. It is desired to deliver a dose of 1% carbon dioxide by weight of cement (bwc) to successive batches of concrete in different trucks over the course of a day. Trucks may be full loads of 10 cubic yards of concrete, or partial loads with as little as 1 cubic yard of concrete. The typical batch of concrete uses 15% by weight cement, and a typical cubic yard of concrete has a weight of 4000 pounds, so a cubic yard of concrete will contain 600 pounds of cement. Thus, the lowest dose of carbon dioxide will be 6 pounds and the highest dose 60 pounds. The time between doses averages at least 10 minutes.

Liquid carbon dioxide is led from a tank to an orifice configured to convert the liquid carbon dioxide to solid and gaseous carbon dioxide upon its release to atmospheric pressure via a 10-foot line of ⅜ inch ID braided stainless steel. Upon its release through the orifice, the mixture of solid and gaseous carbon dioxide is led toward the drum of a ready mix truck via a 50-foot line of ⅝ inch ID, smooth bore and insulated. This line terminates in a 2 inch ID stainless steel tube of ¼ inch thickness and 2 feet long that is contained inside the chute that leads concrete ingredients from their respective storage containers to the drum of the truck; the stainless steel line in turn terminates in a flexible section fitted over the steel tube that moves with the rubber boot at the end of the chute that flops into the hopper of the ready-mix truck.

The system is calibrated against a calibration system using the same length, diameter, and material of the initial conduit, tested for flow rate under a variety of temperature and pressure conditions. Appropriate pressures and temperatures are taken during the operation of the system for a given batch and matched to the appropriate calibration curve or curves to determine flow rate and length of time needed to deliver the desired dose, and carbon dioxide flow is ceased when the system has determined that a dose of 1% bwc has been delivered to a truck.

Ambient temperatures of the day range between 10 and 25° C. Each truck remains in the loading area while materials are loaded for a maximum of 90 seconds, and delivery time for the carbon dioxide is less than 45 seconds.

The system delivers appropriate doses to achieve 1% carbon dioxide bwc, at a ratio of solid/total carbon dioxide of at least 0.4, over the course of 8 hours, with an average of 5 loads per hour (40 loads total), with a precision of less than 10% coefficient of variation.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for intermittently delivering a dose carbon dioxide in solid and gaseous form to a destination comprising
(i) transporting liquid carbon dioxide from a source of liquid carbon dioxide to an orifice via a first conduit, wherein
(a) the first conduit comprises material that can withstand the temperature and pressure of the liquid carbon dioxide, and
(B) the pressure drop through the orifice and the configuration of the orifice are such that solid and gaseous carbon dioxide are produced as the carbon dioxide exits the orifice;
(ii) transporting the solid and gaseous carbon dioxide through a second conduit,
wherein the ratio of the length of the second conduit to the length of the first conduit is at least 1:1; and
(iii) directing the carbon dioxide that exits the second conduit to a destination.

2. The method of claim 1 further wherein the length, diameter, and material of the first conduit are such that, after a transition period, the liquid carbon dioxide entering the first conduit arrives at the orifice as at least 90% liquid carbon dioxide when the ambient temperature is less than 30° C.

3. The method of claim 1 further wherein the second conduit has a smooth bore.

4. The method of claim 1 wherein the first conduit is not insulated.

5. The method of claim 1 further comprising directing the solid and gaseous carbon dioxide from the end of the second conduit into a third conduit, wherein the third conduit comprises a portion configured to slow the flow of the carbon dioxide through the portion of third conduit sufficiently to cause the solid carbon dioxide to clump before it exits the third conduit through an opening.

6. The method of claim 5 wherein the portion of the third conduit configured to slow the flow of carbon dioxide is an expanded portion compared to the second conduit.

7. The method of claim 5 wherein the ratio of the length of the third conduit to the length of the second conduit is less than 0.1:1.

8. The method of claim 5 wherein the third conduit has a length between 1 and 10 feet.

9. The method of claim 5 wherein the third conduit has an inner diameter between 1 inch and 3 inches

10. The method of claim 1 wherein the ratio of the length of the second conduit to that of the first conduit is at least 2:1.

11. The method of claim 1 wherein the first conduit has a length of less than 15 feet.

12. The method of claim 1 wherein the first conduit has an inner diameter between 0.25 and 0.75 inches.

13. The method of claim 1 wherein the first conduit comprises inner material of braided stainless steel.

14. The method of claim 1 wherein the second conduit has a length of at least 30 feet.

15. The method of claim 1 wherein the second conduit has an inner diameter between 0.5 and 0.75 inch.

16. The method of claim 1 wherein the second conduit comprises inner material of PTFE.

17. The method of claim 5 wherein the third conduit comprises rigid material, and is operably connected to a fourth conduit comprising flexible material.

18. The method of claim 17 wherein the combined length of the third and fourth conduits is between 2 and 10 feet.

19. The method of claim 1 wherein the first conduit comprises a valve for regulating the flow of carbon dioxide, wherein the method further comprising determining a pressure and a temperature between the valve and the orifice, and determining a flow rate for the carbon dioxide based on the temperature and the pressure.

20. The method of claim 19 wherein the flow rate is determined by comparing the pressure and temperature to a set of calibration curves for flow rates at a plurality of temperatures and pressures.

21. The method of claim 1 wherein the destination to which the carbon dioxide is directed is within a mixer.

22. The method of claim 21 wherein the mixer is a concrete mixer.

23. The method of claim 22 wherein the carbon dioxide is directed to a place in the mixer where, when the mixer is mixing a concrete mix, a wave of concrete folds over onto the mixing concrete.

24. The method of claim 22 wherein the concrete mixer is a stationary mixer.

25. The method of claim 22 wherein the mixer is a transportable mixer.

26. The method of claim 25 wherein the mixer is a drum of a ready-mix truck.

27. The method of claim 1 wherein the total heat capacity of the first and/or second conduit is no more than X.

28. The method of claim 1 wherein the configuration of the orifice and are such that solid and gaseous carbon dioxide exits the orifice in a mixture that comprises at least 40% solid carbon dioxide when the dose of carbon dioxide through the orifice is less than X weight/mass and the first conduit has reached a temperature of at least Y degrees centigrade prior to introduction of liquid carbon dioxide into the first conduit.

29. The method of claim 17 wherein the conduits are directed to add carbon dioxide to a concrete mixer, and wherein cement is added to the mixer through a cement conduit comprising a first portion comprising a rigid chute connected to a second portion comprising a flexible boot configured to allow a ready-mix truck to move a hopper on the ready-mix into the boot so that the boot flops into the hopper, allowing cement and other ingredients to fall into a drum of the ready-mix truck through the boot, wherein the third conduit is positioned alongside the first portion of the cement conduit and the fourth conduit is positioned to move and direct itself with the second portion of the cement conduit.

30. The method of claim 29 wherein aggregate is added to the mixer through an aggregate chute adjacent to the cement chute, and where the first portion of the third conduit is positioned to reduce contact with aggregate as it exits the aggregate chute.

31. The method of claim 29 wherein the first portion of the third conduit extends to the bottom of the first portion of the cement chute and the forth conduit is attached to the end of the third conduit, and extends from the end of the third conduit to the bottom of the rubber boot or near the bottom of the rubber boot when the rubber boot is positioned within the hopper of the ready-mix truck.

32. The method of claim 29 wherein the fourth conduit is positioned within x cm of the center of the rubber boot, on average, where x=1, 2, 3, 4, 5, 6, 7, 8, 9, 10, 12, 15, 20, 25, 30, 35, 40, 45, 50, 60, 70, 80, or 90 cm when the rubber boot is positioned to load concrete materials into the drum of the ready-mix truck.

33. An apparatus for delivering solid and gaseous carbon dioxide comprising
(i) a source of liquid carbon dioxide;
(ii) a first conduit, wherein the first conduit comprises a proximal end operably connected to the source of liquid carbon dioxide, and a distal end operably connected to an orifice, wherein the first conduit is configured to transport liquid carbon dioxide under pressure to the orifice, and wherein the orifice is open to atmospheric pressure, or close to atmospheric pressure, and is configured to convert the liquid carbon dioxide to a mixture of solid and gaseous carbon dioxide as it passes through the orifice;
(iii) a second conduit operably connected to the orifice for directing the mixture of gaseous and solid carbon dioxide to a desired destination, wherein the second conduit has a smooth bore, and wherein the ratio of the length of the first conduit to the length of the second conduit is less than 1:1.

34. The apparatus of claim 33 wherein the ratio of the length of the first conduit to the length of the second conduit is less than 1:2.

35. The apparatus of claim 33 wherein the ratio of the length of the first conduit to the length of the second conduit is less than 1:5.

36. The apparatus of claim 33 wherein the first conduit is less than 20 feet long.

37. The apparatus of claim 33 wherein the first conduit is less than 15 feet long.

38. The apparatus of claim 33 wherein the first conduit is less than 12 feet long.

39. The apparatus of claim 33 wherein the first conduit is less than 5 feet long.

40. The apparatus of claim 33 wherein the first conduit comprises a valve prior to the orifice to regulate the flow of the liquid carbon dioxide.

41. The apparatus of claim 40 further comprising a first pressure sensor between the valve and the orifice.

42. The apparatus of claim 40 further comprising a second pressure sensor between the source of liquid carbon dioxide and the valve.

43. The apparatus of claim 40 further comprising a third pressure sensor after the orifice.

44. The apparatus of claim 41 further comprising a temperature sensor between the valve and the orifice.

45. The apparatus of claim 44 further comprising a control system operably connected to the first pressure sensor and the temperature sensor.

46. The apparatus of claim 44 wherein the controller receives a pressure from the first pressure sensor and a temperature from the temperature sensor and calculates a flow rate of carbon dioxide in the system from the pressure and temperature.

47. The apparatus of claim 46 wherein the controller calculates the flow rate based on a set of calibration curves for the apparatus.

48. The apparatus of claim 47 wherein the set of calibration curves is produced with a calibration setup comprising a source of liquid carbon dioxide, a first conduit, an orifice, a valve in the first conduit before the orifice, a pressure sensor between the valve and the orifice, and a temperature sensor between the valve and the orifice, wherein the material of the first conduit, the length and diameter of the first conduit, and the material and configuration of the orifice, are the same as or similar to those of the apparatus.

49. The apparatus of claim 48 wherein the set of calibration curves is produced by determining the flow of carbon dioxide at a plurality of temperatures as measured at the temperature sensor and a plurality of pressures as measured at the pressure sensor.

50. The apparatus of claim 33 further comprising a third conduit, operably attached to the second conduit, wherein the third conduit has a larger inside diameter than the second conduit and wherein the diameter and length of the third conduit are configured to slow the flow of the gaseous and solid carbon dioxide and to cause clumping of the solid carbon dioxide.

51. The apparatus of claim 33 wherein the first conduit is not insulated.

52. A system for delivering solid and gaseous carbon dioxide in an intermittent manner at doses of carbon dioxide of less than 60 pounds, with a time between doses of at least 5 minutes, wherein the system is configured to deliver repeated doses with a ratio of solid to gaseous carbon dioxide of at average of least 1:1.5 in each dose, in less than 60 seconds per dose, at an ambient temperature of 35° C. or less.

53. The system of claim 52 wherein the system is configured to deliver the repeated doses of carbon dioxide with a coefficient of variation of less than 10%.

54. The system of claim 52 wherein the system is configured to deliver repeated doses of carbon dioxide with a coefficient of variation of less than 5%.

55. The system of claim 52 comprising a source of liquid carbon dioxide and a conduit from the source to an apparatus configured to convert the liquid carbon dioxide to solid and gaseous carbon dioxide, wherein the conduit is not required to be insulated.

56. The system of claim 55 wherein the conduit is not insulated.

57. The system of claim 55 further comprising a second conduit connected to the apparatus to convert the liquid carbon dioxide to solid and gaseous carbon dioxide, wherein the second conduit delivers the solid and gaseous carbon dioxide to a desired location.

58. The system of claim 57 wherein the ratio of lengths of the first conduit to the second conduit is less than 1:1.

59. An apparatus for delivering solid and gaseous carbon dioxide in low doses in an intermittent manner of repeated doses of solid and gaseous carbon dioxide comprising
(i) a source of liquid carbon dioxide;
(ii) a first conduit, wherein the first conduit comprises a proximal end operably connected to the source of liquid carbon dioxide, and a distal end operably connected to an orifice, wherein the first conduit is configured to transport liquid carbon dioxide under pressure to the orifice, and wherein the orifice is open to atmospheric pressure and is configured to convert the liquid carbon dioxide to a mixture of solid and gaseous carbon dioxide as it passes through the orifice;
(iii) a valve in the conduit between the source of carbon dioxide and the orifice, to regulate the flow of liquid carbon dioxide;
(iv) a heat source operable connected to the section of conduit between the valve and the orifice, and to the orifice, wherein the heat source is configured to warm the conduit and orifice between doses to convert liquid or solid carbon dioxide to gas which is vented through the orifice.

60. The apparatus of claim 59 further comprising a heat sink operably connected to the heat source.

61. The apparatus of claim 59 further comprising (v) a second conduit operably connected to the orifice for directing the mixture of gaseous and solid carbon dioxide to a desired destination

62. The apparatus of claim 61 wherein the second conduit has a smooth bore.

63. The apparatus of claim 61 wherein the ratio of the length of the first conduit to the length of the second conduit is less than 1:1.
